(19) United States
(12) Patent Application Publication
(10) Pub. No.: US 2006/0134290 A1
(43) Pub. Date: Jun. 22, 2006

(54) Process for preventing development of off flavor in ctc teas using anitoxidants

(75) Inventors: Nagalakshmi Sreekantayya, Karnataka (IN); Jagan Mohan Rao Lingamallu, Karnataka (IN); Chandrasekhar Nanjundaswamy, Karnataka (IN); N. Muraleedharan, Tamilnadu (IN)

Correspondence Address: NORRIS, MCLAUGHLIN & MARCUS, P.A., 875 THIRD AVE, 18TH FLOOR, NEW YORK, NY, 10022, US

(73) Assignee: Council of Scientific and Industrial Research, New Delhi (IN)

(21) Appl. No.: 10/540,166

(22) PCT Filed: Dec. 18, 2002
(86) PCT No.: PCT/IB02/05462

§ 371 Date: Jan. 25, 2006

(51) Int. Cl. C11B 5/00

(52) U.S. Cl. 426/541

(57) ABSTRACT

A present invention relates to a process for preventing development of pacha taint in CTC teas using antioxidants said process comprising diluting the antioxidant emulsion; spraying the emulsion homogenously on the fermented tea material; drying, grading, packing and storing the dried material.

### TECHNICAL FIELD

The present invention related to a process for preventing development of pacha taint in CTC (Crush Tear Curl) teas using antioxidants

### BACKGROUND ART

Tea is the most popular beverage and one of the earliest known beverages in the world. Tea refers to the plant Camellia sinenesis; the dried, processed leaf manufactured from it, extracts derived from the leaf, and beverages prepared from the leaf or extracts of this species. The development of the most characteristic attributes of the tea, i.e. the flavour and colour of the beverage is dependent on the manipulation of tealeaves to induce certain biochemical changes (Scott, 1964, Biotechnology, 5; 577). The starting material for manufacturing tea consists of tender young shoots, usually two or three leaves and the bud of the tea plant. The chemical composition of these shoots and the reactions that occur during the process determine the nature of the finished product.

During the processing and then storing, certain off flavours along with desired flavours develop in the tea. ‘Green note’ is one such flavour. This off flavour which is developed in storage after three to four weeks from manufacture is also called ‘grassy’, ‘fishy’ or ‘painty’ flavour and commonly known as ‘pacha taint’ (Ganeshan and Ramaswamy, February, 1996, The Planters chronicle, p 91). A grassy, fishy or painty smell is called “pacha taint”

This type of off-flavour was reported in the Wynaad and Nilgini-Wynaad regions during certain periods of the year in CTC teas after 3-6 weeks of storage. When the teas were fresh, professional tasters report these as normal. Pacha taint has become a serious concern for the planters and traders of tea in the Wynaad and Nilgiri-Wynaad areas. The price of the pacha-tainted tea is low, when compared to normal tea. Due to this problem, the planters are not getting suitable price for their product. Hence, it was thought that the prevention of development of pacha taint is the urgent need.

This taint or off-flavour is increasingly becoming a menace in tea industry. This taint occurs mainly during the storage after the manufacturing is accomplished. The chemical constituents mainly responsible for the formation of this odour/taint are C₆ aldehydes and C₆ alcohols. These compounds are formed when the lipid degradation followed by fatty acid oxidation takes place. The lipids not degraded during the manufacturing process degrade during storage and the off flavour is produced.

Several other factors enhance the development of grassy aroma in tea, such as low temperature of firing, increased plucking intervals, type and period of withering, rolling, fermentation etc. Various environmental conditions also have a role to develop this taint.

Antioxidants play a crucial role in preventing or delaying autoxidation and have attracted a lot of attention as food additives. The deterioration of food with time results from its biological nature largely and is inevitable. During the production, processing, distribution and storage prior to actual consumption, food undergoes various modes of deterioration that involve biological changes by microbes as well as chemical changes. The latter is ascribed to enzymatic and non-enzymatic oxidation of lipids and phenolic substance, which cause undesirable changes in flavour, appearance, physical character, nutritional value and toxicity. Deoxygenation, airtight packing, and other techniques have solved some of these problems to a certain extent, but the role of antioxidants as either food constitutents or as additives cannot be overlooked. Both synthetic and natural antioxidants are widely used in many food products.

Literature survey revealed that there is no report on the prevention of the development of this off-flavour. BHA (Butylated hydroxy anisole) is one of the known synthetic antioxidant allowed as food additive in food processing at ppm levels.

### OBJECTS OF THE INVENTION

The main object of the present invention is to provide a process for preventing development of pacha taint in CTC teas using antioxidants.

Another object of the present invention is to keep CTC teas devoid of pacha-taint during storage.

### SUMMARY OF THE INVENTION

Accordingly, the present invention provides a process for the prevention of development of pacha taint in CTC teas using antioxidants which comprises, diluting the antioxidant emulsion; spraying the emulsion homogeneously on the fermented tea material; drying, grading, packing and storing the packed material.

### DETAILED DESCRIPTION OF THE INVENTION

In accordance to the objectives of the present invention, the process provides a CTC tea which is devoid of pacha taint, said process comprising the steps of:
(i) diluting emulsion of an antioxidant in a suitable medium,
(ii) spraying the emulsion homogeneously on the fermented tea material in the black tea manufacturing process,
(iii) drying the above material and packing suitably, and
(iv) storing of the packed material.

In an embodiment of the invention provides a process, wherein the medium used for diluting the antioxidant is as aqueous medium.

Another embodiment, the ratio of emulsion of antioxidant and diluting medium is in 1:200 to 500.

Still another embodiment, the antioxidant used in step (i) is a synthetic antioxidant and/or related antioxidants.

Still another embodiment, the antioxidant used is butylated hydroxy anisole (BHA).

Yet another embodiment, the amount of antioxidant used is in the range of 0.001 to 0.05% weight percent.

Yet another embodiment, the sprayer used in step (ii) may be able to spray one litre of solution in 5-8 minutes.

Yet another embodiment, the dryer used in step (iii) is VFB type dryer.

Yet another embodiment, the drying is carried out at a temperature range of 110 to 140° C.

Yet another embodiment, the grading of the dried material is as per the size of the particles.

One more embodiment, the dried material is packed using suitable packing material selected from polythene bags, polythene lined gunny bags and LDPE bags.

Another embodiment, the packed material is under ambient conditions.

In yet another embodiment, a professional taster may do the sensory evaluation of the packed material, and it is evaluated for a period of 6-8 weeks at two weeks intervals.

A process for the prevention of development of pacha taint in CTC teas using antioxidants carried out according to following flow diagram.

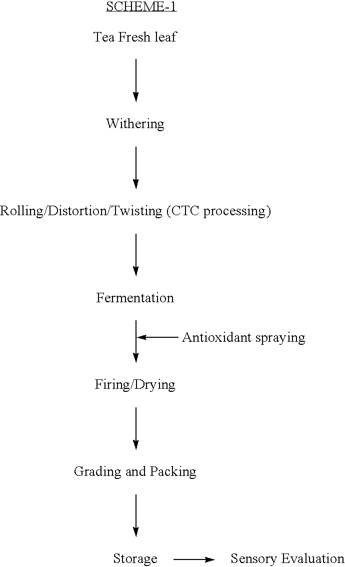

Sensory evaluation: Appearance of the product is observed. 8 g of SFD is brewed in 142 ml of boiling water for 5 min. The colour, aroma and taste of the brew are scored on a ten-point scale. The colour, aroma and flavour of the infusion are also scored on a ten-point scale. Taster's remarks are presented.

The Advantages of the Process are:

This is the first report of a process for the prevention of development of pacha taint in CTC teas using antioxidants.

The antioxidant used is a PFA (Prevention of Food Adulteration Act) allowed compound.

The novelty of the process is the use of antioxidant for preventing development of pacha taint in CTC teas.

The following examples are given by the way of illustration only and should not be construed to limit the scope of the present invention.

### EXAMPLE 1

Tealeaf (1500 g) withered for 18 h. Leaves were subjected to distortion using rotarvane and CTC machine. Twisted leaf is mixed with RC and subjected to fermentation at 27° C. for 50-60 min. The antioxidant (30-50 mg) emulsion is diluted and sprayed on to the fermented leaf manually. Fermented leaves are subjected to drying in a Fluidized bed dryer until the moisture is reduced to 3%. Manufactured black tea is subjected to sieving manually to separate different grades. Super fine dust (SFD) is packed separately and kept for storage. It is subjected to sensory evaluation at two weeks. The scores are presented in the following tables.

### EXAMPLE 2

Tea leaves (500 Kg) withered for 14-20 h. Leaves were subjected to distortion using one rotarvane and four CTC machines in series RC is mixed with leaf during distortion. Distorted leafy material is subjected to Drum fermentation at 27° C. for 50-60 min in drums under special conditions. The antioxidant (10-15 g) emulsion (40 ml) is diluted to 10 L with water and sprayed on to the fermented leaf using power sprayer. Fermented leafy material is subjected to drying in a Fluidized bed dryer until the moisture is reduced to 3%. Manufactured black tea is subjected to mechanical sieving to separate different grades. Super fine dust is packed separately and kept for storage. It is subjected to sensory evaluation at two weeks interval for three months. The scores are presented in the following tables.

Chemical Parameters of SFD (Super Fine Dust) Samples from Nilgiri-Wynad Region Factory Trials

| | Lipid | Leaf | Lipid (%) | Leaf Aldehyde | Taster's | Taster's |
|---|---|---|---|---|---|---|
| | (%) | aldehyde | (After 4 | (μg %) (After | Score | Score |
| Samples | (Initial) | (μg %) (Initial) | weeks) | 4 weeks) | Initial | After 4Weeks |
| T1-(BHA) | 7.00 | 1478 | 6.01 | 1454 | 8 | 7 |
| T2-Control | 7.43 | 2070 | 6.48 | 1778 | 8 | 5 |
| T8-Control | 7.43 | 2070 | 6.93 | 1886 | 8 | 5 |
| T9-(BHA) | 6.98 | 1456 | 6.04 | 1358 | 7 | 7 |

After 4 weeks the taster's score remained unaltered, indicating the samples remained good.

1. A process for the prevention of development of pacha taint in CTC teas, said process comprising the steps of:
a. diluting emulsion of an antioxidant in a suitable medium,
b. spraying the emulsion homogeneously on the fermented tea material in the black tea manufacturing process,
c. drying the above material and packing suitably, and
d. storing of the packed material.

2. The process as claimed in claim 1, wherein the suitable medium used for diluting the antioxidant is as aqueous medium.

3. The process as claimed in claim 1, wherein the ratio of emulsion of antioxidant and diluting medium is in 1:200 to 500.

4. The process as claimed in claim 1 wherein, the antioxidant used in step (i) is a synthetic antioxidant and/or related antioxidants.

5. The process as claimed in claim 1, wherein the antioxidant used is butylated hydroxy anisole (BHA).

6. The process as claimed in claim 1, wherein the amount of antioxidant used is in the range of 0.001 to 0.05% weight percent

7. The process as claimed in claim 1, wherein the sprayer used in step (ii) may be able to spray one litre of solution in 5-8 minutes.

8. The process as claimed in claim 1, wherein the drier used in step (iii) is selected from fluidised bed type drier, VFB drier and any suitable drier.

9. The process as claimed in claim 1, wherein the drying is carried out at a temperature range of 110 to 140° C.

10. The process as claimed in claim 1, wherein in step (iv), the grading of the dried material is as per the size of the particles.

11. The process as claimed in claim 1, wherein the dried material is packed using suitable packing material selected from polythene bags, polythene lined gunny bags and LDPE bags.

12. The process as claimed in claim 1, wherein the packed material is under ambient conditions.

13. The process as claimed in claim 1, wherein the CTC tea obtained is devoid of pacha-taint when stored up to 10 weeks.

14. The process as claimed in claim 1, wherein the sensory evaluation of the material in step (vi) may be done by a professional taster/laboratory panel of tasters
